(19) United States
(12) Patent Application Publication
(10) Pub. No.: US 2023/0278106 A1
(43) Pub. Date: Sep. 7, 2023

(54) Three-Dimensional (3D) Printing System with Improved Layer-to-Layer Contour Generation to Improve Surface Quality

(71) Applicant: LAYERWISE NV, Leuven (BE)

(72) Inventors: Nachiketa Ray, Leuven (BE); Gokula Krishna Muralidharan, Gent (BE)

(21) Appl. No.: 18/175,604

(22) Filed: Feb. 28, 2023

Related U.S. Application Data
(60) Provisional application No. 63/316,797, filed on Mar. 4, 2022.

(51) Int. Cl. B22F 10/36; B22F 10/28; B22F 12/30; B22F 10/85; B33Y 10/00; B33Y 30/00; B33Y 50/02

(52) U.S. Cl. CPC B22F 10/36; B22F 10/28; B22F 10/85; B22F 12/30; B33Y 10/00; B33Y 30/00; B33Y 50/02

(57) ABSTRACT

A three-dimensional (3D) printing system for forming a 3D article includes a print engine and a controller. The print engine includes a build plate, a coater, and a plurality of beam units. The coater is configured to coat a layer of fusible powder over the build plate to span a build plane. The first beam unit is configured to generate and scan an energy beam over a first lateral region of the build plane. The second beam unit is configured to generate and scan an energy beam over a second lateral region of the build plane. The first and second lateral regions overlap over an overlap zone. In forming contours, the controller is configured to define sub-contours that connect along a seam within a layer. In the overlap zone, the sub-contours have an offset along the seam that varies from layer to layer.

### CROSS REFERENCE TO RELATED APPLICATIONS

This non-provisional patent application claims priority to U.S. Provisional Application Serial Number 63/316,797, Entitled “Three-Dimensional (3D) Printing System with Improved Layer-to-Layer Contour Generation to Improve Surface Quality” by Nachiketa Ray et al., filed on Mar. 4, 2022, incorporated herein by reference under the benefit of U.S.C. 119(e).

### FIELD OF THE INVENTION

The present disclosure concerns an apparatus and method for the fabrication of three dimensional (3D) articles utilizing powder materials. More particularly, the present disclosure concerns a manufacturing strategy that improves an external surface finish of the articles when multiple energy beams are used.

### BACKGROUND

Three dimensional (3D) printing systems are in rapidly increasing use for purposes such as prototyping and manufacturing. One type of three dimensional printer utilizes a layer-by-layer process to form a three dimensional (3D) article of manufacture from powdered materials. Each layer of powdered material is selectively fused using an energy beam such as a laser, electron, or particle beam. Higher productivity printers can utilize multiple energy beams. One challenge with multiple energy beams is a transition from using one energy beam to another. When an outer surface of the 3D article overlaps a transition zone one artifact is a rough surface finish.

### SUMMARY

A first aspect of the disclosure is a three-dimensional (3D) printing system for forming a 3D article. The 3D printing system includes a print engine and a controller. The print engine includes a (motorized) build plate, a coater, and a plurality of beam units. The motorized build plate includes a vertical actuator coupled to a build plate. The build plate has an upper surface. The coater is configured to coat a layer of fusible powder over the upper surface of the build plate to span a build plane. The first beam unit is configured to generate and scan an energy beam over a first lateral region of the build plane. The second beam unit is configured to generate and scan an energy beam over a second lateral region of the build plane. The first and second lateral regions overlap over an overlap zone.

The controller is configured to operate the motorized build plate, the coater, and the plurality of beam units to form the 3D article. The operation to form the 3D article includes forming a sequence of N selectively fused powder layers in which N is at least 3. During forming the sequence of N selectively fused powder layers the controller is further configured to operate the first beam unit to selectively solidify a first sub-contour(n) having a first end(n) within the overlap zone and operate the second beam unit to selectively solidify a second sub-contour(n) having a second end(n) within the overlap zone. The first end(n) and the second end(n) connect to form a seam(n) that is oriented along a lateral Y-axis. For N-1 layers the first end(n) and the second end(n) are offset with respect to each other along the seam(n), the offset varying over the sequence of N selectively fused powder layers. No two layers within the sequence of N layers have the same offset. The layer to layer offset over the sequence improves a surface finish of an outer surface of the 3D article when there is an alignment uncertainty between the first beam unit and the second beam unit.

In one implementation the seam(n) has a varying location with respect to a lateral X-axis over a sequence of M selectively fused powder layers. M is at least 3. M can equal N and can be the same sequence of selectively fused powder layers. The varying location of the seam(n) can vary in steps of size δX. The varying offset of the second end(n) with respect to the first end(n) can vary in steps of δY. The magnitude of δX is at least m = 10 times the magnitude of δY which is equivalent to the ratio of δX over δY of at least m = 10. In various other embodiments, the ratio of δX over δY is at least 20, 30, 40, 50, 100, 200, 500, or 1000. In various embodiments, the magnitude of δX can vary between 1 millimeter (1 mm) and 10 millimeters (10 mm). The magnitude of δY can be about 5 microns (0.005 mm) or take on other values that are smaller or larger than 5 microns but are always less than 10% of δX.

For a given value of M, an offset along X can take on M different values that are integer multiples of δX including zero. For a given value of N, an offset along Y can take on N different values that are integer multiples of δY including zero. M can equal N.

In another implementation the print engine includes a gas handling system configured to flow a non-oxidizing gas generally along the Y-axis during operation of the first and second beam units.

In yet another implementation, within the sequence of N layers any two different layers have a difference in Y-offset of at least 5 microns. The first beam unit and the second beam unit have a relative alignment uncertainty ΔY along the Y-axis. The Y-offset is no more than 50% of ΔY.

In a further implementation, within the sequence of N layers any two different layers have a difference in Y-offset of at least 5 microns. The plurality of beam units can form a melt pool width (W) and the offset along the Y-axis is no more than 50% of W.

A second aspect of the disclosure is a method of forming a 3D article using the system of the first aspect of the disclosure. The method improves a surface finish of an outer surface of the 3D article when there is an alignment uncertainty between the first beam unit and the second beam unit.

A third aspect of the disclosure is a non-transitory computer readable storage medium for operating the system of the first aspect of the disclosure. The controller of the system of the first aspect of the disclosure operates when software stored upon the non-transitory computer readable storage medium is executed by a processor to operate the motorized build plate, the coater, and the plurality of beam units according to the limitations of the first aspect of the disclosure.

### BRIEF DESCRIPTION OF THE FIGURES

FIG. 1 is a schematic diagram of a three-dimensional (3D) printing system for fabricating a 3D article.

FIG. 2 is a flowchart depicting a method for fabricating the 3D article.

FIG. 3A illustrates a 3D article having a geometry of a right cylinder with an elliptical cross section.

FIG. 3B is a schematic illustration of a fused layer(n) of a 3D article having an elliptical cross section.

FIG. 3C is a diagram illustrating a build plane with a scan pattern for fusing the slice(n) of FIG. 3B.

FIG. 4 illustrates a portion of a build plane with emphasis on a portion of a contour that extends through an overlap zone. Two different beam systems address the overlap zone.

FIG. 5A depicts a seam formed by the connection between two sub-contours. In FIG. 5A, the seam is in a nominal location with respect to an X-axis. The location of the seam with respect to X can be defined as the X-value of a midpoint or centroid of the seam.

FIG. 5B depicts a seam formed by the connection between two sub-contours. In FIG. 5B, the seam is shifted by -δX from the nominal value of X.

FIG. 5C depicts a seam formed by the connection between two sub-contours. In FIG. 5C, the seam is shifted by +δX from the nominal value of X.

FIG. 6A depicts a seam formed by the connection between two sub-contours. In FIG. 6A, the seam is in a nominal location with respect to an X-axis. Also, the sub-contours are aligned across the seam.

FIG. 6B depicts a seam formed by the connection between two sub-contours. In FIG. 6B, the seam is shifted by -δX from the nominal value of X. Also, a second sub-contour is offset by a non-zero positive relative offset +δY along Y and along the seam with respect to a first contour.

FIG. 6C depicts a seam formed by the connection between two sub-contours. In FIG. 6C, the seam is shifted by +δX from the nominal value of X. Also, a second sub-contour is offset by a non-zero negative relative offset -δY along Y and along the seam with respect to a first contour.

FIG. 7A is a flowchart for preparing slice data for printing.

FIG. 7B is a flowchart for operating a print engine using the slice data from FIG. 7A.

### DETAILED DESCRIPTION OF THE PREFERRED EMBODIMENTS

FIG. 1 is a schematic diagram of a three-dimensional (3D) printing system 2 for fabricating a 3D article 4. 3D printing system 2 includes a 3D print engine 6 coupled to a controller 8. In describing system 2, mutually orthogonal axes X, Y, and Z can be used. The X and Y axes are lateral and generally horizontal. The Z-axis is a vertical axis that is generally aligned with a gravitational reference. By “generally” we mean that a measure such as a quantity, a dimensional comparison, or an orientation comparison is by design and within manufacturing tolerances but as such may not be exact.

In the illustrated embodiment, the print engine 6 includes a build box 10 contained within build chamber 12 defined by an outer housing 14. A gas handling system 16 is configured to control a gaseous environment within build chamber 12. The gas handling system 16 is also configured to control a flow of a non-oxidizing gas within the build chamber 12. In the illustrated embodiment, the non-oxidizing gas is argon. Other non-oxidizing gases such as nitrogen be used in other embodiments. The gas handling system 16 can include vacuum pumps, pressurized gas cannisters (such as Argon cannisters), valves, fans, and other components under control of controller 8.

The build box 10 includes a (motorized) build plate 18 having an upper surface 19. A vertical motion actuator 20 is coupled to the build plate 18 and is configured to control a vertical position of build plate 18. The vertical actuator 20 can take on a number of forms. One example of a vertical actuator 20 is a rack and pinion actuator in which a motorized circular pinion gear engages a linear rack gear that is coupled to the build plate 18. Rotation of the pinion gear would thereby vertically translate the build plate 18. Alternatively the vertical actuator 20 can include a motorized lead screw that is threaded into a nut. The nut is mechanically coupled to the build plate 18. Thus, rotation of the lead screw would vertically translate the build plate 18. A motor of either type of actuator 20 is under control of the controller 8 to allow for an accurate vertical positioning of the build plate 18.

A coater 22 is configured to dispense layers of fusible powder 24 over the upper surface 19 of build plate 18. The coater 22 can take on any number of forms including a dispenser that selectively coats portion of an upper surface or an elongate slotted coater configured to coat all or nearly all of the entire upper surface of the build plate 18. When a new layer of powder 24 has been dispensed, it has an upper surface 26 which can vertically correspond to a build plane 28 when the build plate 18 is properly positioned. In the illustrated embodiment, the fusible powder 24 is a metal powder that can be an elemental metal such as titanium or an alloy.

The coater 22 can include a powder coating mechanism that is transported along the X axis with a lead screw or a belt and pulley system under control of controller 8. The powder coating mechanism can include a metering device such as a motorized roller or valve that accurately meters a layer of fusible or meltable powder having an upper surface 26 defining build plane 28.

A plurality of beam systems or units 30 individually generate and direct energy beams 32 across lateral regions of the build plane 28. In an illustrative embodiment, a beam system 30 includes a laser for selectively melting metal powder. A single beam 32 can have an average optical power level of at least 100 Watts, at least 500 Watts, a Kilowatt, or more than a Kilowatt. The beam system 30 can include the laser for generating the beam 32 and a pair of galvanometer mirrors for scanning the beam 32 across the build plane 28. In an alternative embodiment, the beam system 30 generates and scans and electron beam 32. In hybrid embodiments, the beam systems 30 can generate both optical radiation beams 32 and electron beams 32.

The beam systems 30 have a relative and lateral alignment uncertainty with respect to each other along X and Y. The lateral alignment uncertainty for plural beams is equal to the joint lateral location variability of the two beams. In an illustrative embodiment, the Y-axis is generally along a direction of gas flow over the build plane 28. The lateral alignment uncertainty along X is equal to ΔX. The lateral alignment uncertainty along Y is equal to ΔY. In the illustrated embodiment, the plurality of beam systems 30 includes a first beam system 30A and a second beam system 30B but can include more than two beam systems. For systems having more than two beam systems 30, lateral alignment uncertainty can be defined between pairs of beam systems 30. For purposes of explanation, only two beam systems 30 will be described, but the same principles apply for any pair of beam systems 30 that have overlapping areas of fusion.

The controller 8 includes a processor 34 and an information storage device 36. Information storage device 36 is a non-volatile or non-transient storage device 36. While a single controller 8 is shown, it is to be understood that controller 8 can refer to a single controller or multiple controllers that are internal and/or external to the print engine 6. Controller 8 may include microcontrollers within print engine 6, server computers, and/or client devices that are coupled to the print engine 6. In the illustrated embodiment, controller 8 includes an external controller 8A and an internal controller 8B.

The information storage device 36 stores software instructions. When executed by processor 34, the software instructions can receive information from print engine 6 such as status information and sensor data. The controller 8 is configured to control portions of the print engine 6 by the execution of the software instructions stored on memory 36 by processor 34. Controller 8 is also configured to process data before operation of the print engine 6.

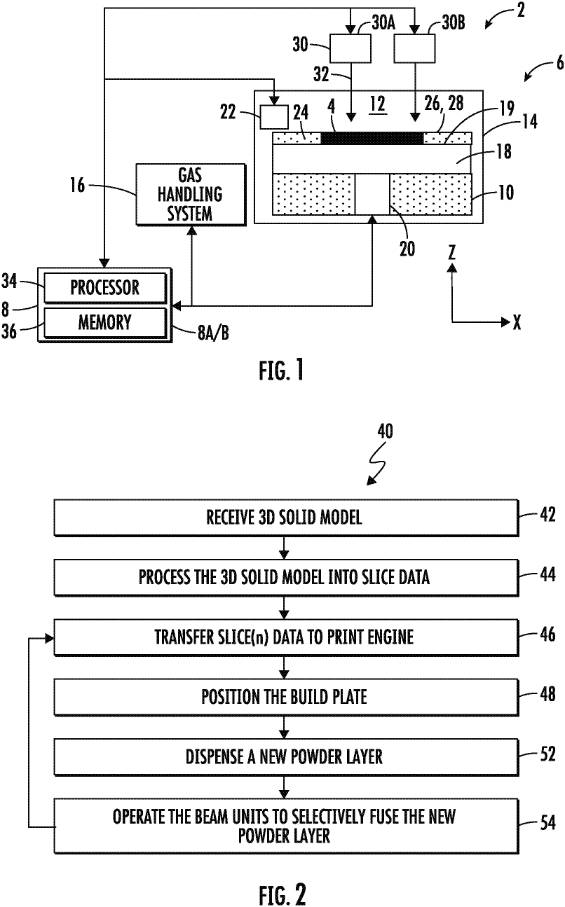

FIG. 2 is a flowchart depicting a method 40 for fabricating the 3D article 4. Controller 8 is configured to perform method 40 including steps 42-54. In some embodiments, controller 8 includes a first controller 8A that performs steps 42-44 and a second controller 8B that performs steps 46-54. Between steps 44 and 46, slice data is transferred from the first controller 8A to the second controller 8B.

According to step 42, a 3D solid model file is received that geometrically defines the 3D article 4. According to step 44, the solid model file is processed to define slice data that defines a plurality of slices. A single slice from among the plurality of slices is referred to as slice(n).

According to 46, single slice(n) data (initially for n = 1) is transferred to the print engine 6. According to 48, the vertical actuator 20 is operated to position the upper surface 19 of build plate 18 proximate to (or one powder layer thickness below) the build plane 28. According to 52, the coater 22 is operated to form a new layer of powder 24 over the upper surface 19 of build plate 18. According to 54, the plurality of beam units 30 are operated to selectively fuse the new layer of powder 24. The process then loops back to 46 and continues until the plurality of slices have been converted into selectively fused layers of the 3D article 4.

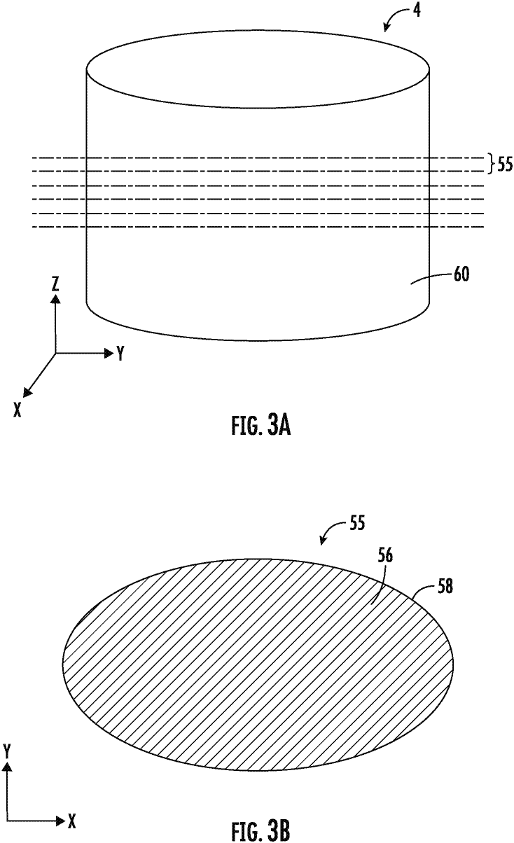

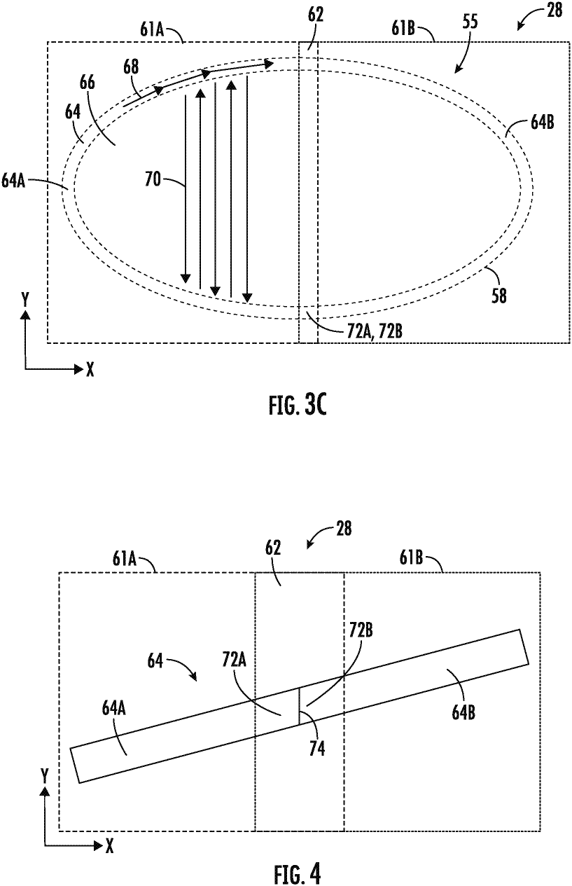

FIGS. 3A-3C are for illustrating some important aspects of slice formation for a simple 3D article 4. FIG. 3A illustrates a very simple 3D article 4 which is a solid metal cylinder having an oval cross section. Element 55 represents a single slice of 3D article 4.

FIG. 3B illustrates a fused layer(n) or slice(n) 55 over lateral axes X and Y. The slice(n) 55 includes a solid interior 56 and an outer boundary 58. The outer boundaries 58 of the plurality of slices 55 collectively form the an outer surface 60 (FIG. 3A) of the 3D article 4.

FIG. 3C depicts build plane 28 with the slice(n) 55 superposed. The build plane includes two overlapping zones including a first zone 61A and a second zone 61B. The first zone 61A is addressable (can be scanned by) the first beam system 30A. The second zone 61B is addressable (can be scanned by) the second beam system 30B. The first zone 61A and second zone 61B overlap, defining an overlap zone 62.

In selectively solidifying the slice 55, the beam systems 30 separately solidify a contour 64 and an area fill hatch region 66. The contour 64 defines the outer boundary 58. In forming contour 64, energy beams 32 are “traced around” the contour 64 with a tail to head series of contour vectors 68. The tail of one contour vector 68 starts immediately after the head of a previous one. For some or all slices, the energy beams 32 may be traced around the full contour 64 more than once to provide a wider contour 64. Contours 64 for a series of layers collectively define the outer surface 60.

Within and minimally overlapping the contour 64 is the area fill hatch region 66. The area fill hatch region 66 is formed by a back and forth array of parallel hatch vectors 70. The parallel hatch vectors 70 can be parallel to X, parallel to Y, or define an oblique angle with respect to X and Y. The hatch vectors 70 have a vector direction and are separated by an offset distance between adjacent hatch vectors 70. The offset distance is selected to assure desired level of solidification of powder in the area fill hatch region 66 but to avoid excessive overlap that might result in overheating.

The contour(n) 64 is formed by two connecting sub-contours including a first sub-contour(n) 64A and a second sub-contour(n) 64B. The first sub-contour(n) 64A is fused by the first beam system 30A and is limited to the first zone 61A. The second sub-contour(n) 64B is fused by the second beam system 30B and is limited to the second zone 61B. The first 64A and second 64B sub-contours(n) individually have an end 72A and 72B that connect within the overlap zone 62. Any connective overlap between ends 72A and 72B is minimized but might be necessary due to the alignment uncertainty between the energy beams 32.

FIG. 4 illustrates a portion of the build plane 28 with emphasis on the contour(n) 64 in the overlap zone 62. Common element numbers in FIG. 4 correspond to those of FIG. 3C. The ends 72 of contours(n) 64A/B meet and connect along a seam(n) 74. The seam(n) 74 is shown as a line, but it is to be understood that the sub-contour(n) ends 72A and 72B may have a small finite overlap and so the seam may be a thin rectangle or parallelogram or other elongate area. An overlap may nominally at least equal a lateral alignment uncertainty along X between beam systems 30A and 30B which is equal to the joint lateral location variability of the two beams 32 with respect to X in the build plane 28.

The fused thickness for a given layer can be different or greater along the seam 74 than the remainder of the contour(n) 64. If layer to layer seams are in the same location, then there can be a cumulative error or a possible material weakness. To eliminate such a potential error or weakness, the seam(n) location along X is varied. One way to do this is to have a sequence of M slices over which no two seams have the same X-values.

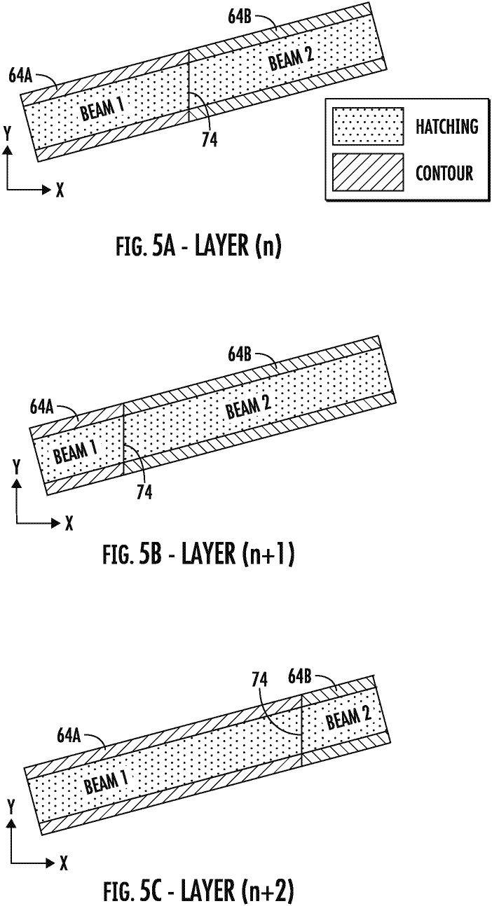

FIGS. 5A-C illustrate variation of seam(n) 74 X values (locational values of the seam along X) for a sequence of M = 3 slices which includes slice or layer n (FIG. 5A), slice n+1 (FIG. 5B), and slice n+2 (FIG. 5C). For layer n, the seam(n) 74 has a nominal X-value. For layer n+1, the seam(n+1) has an X value that is shifted by -δX from the nominal value of X. For layer n+2, the seam(n+2) has an X value that is shifted by +δX from the nominal value of X. For purposes of illustration, we can define the X value of a seam to be the X location of its midpoint.

In various illustrative embodiments, the magnitude of δX is between 1 millimeter (mm) and 10 millimeters (mm). In a particular illustrative embodiments, δX is 1 mm, 2 mm, 3 mm, 4 mm, 5 mm, or some other value between 1 mm and 10 mm. For values of M > 3, the entire span of X values for the seam(n) can vary within a width range of 1 to 20 mm.

While FIGS. 5A-C provide an illustration of M=3, it is to be understood that M can be greater than 3. M can be at least 4, at least 5, at least 6, or some greater value. In an illustrative embodiment, the shift along X for the individual seams can be unique for each layer among the sequence of M layers.

Beams 32 can also have a relative lateral alignment uncertainty ΔY along Y. A result is a surface roughness in a region of the outer boundary 58 which includes the seams 74. To eliminate the surface roughness, the ends 72 of the contours 64A/B are varied from layer to layer with an offset δY along Y. One way to do this is to have a sequence of N slices over which no offsets δY are the same.

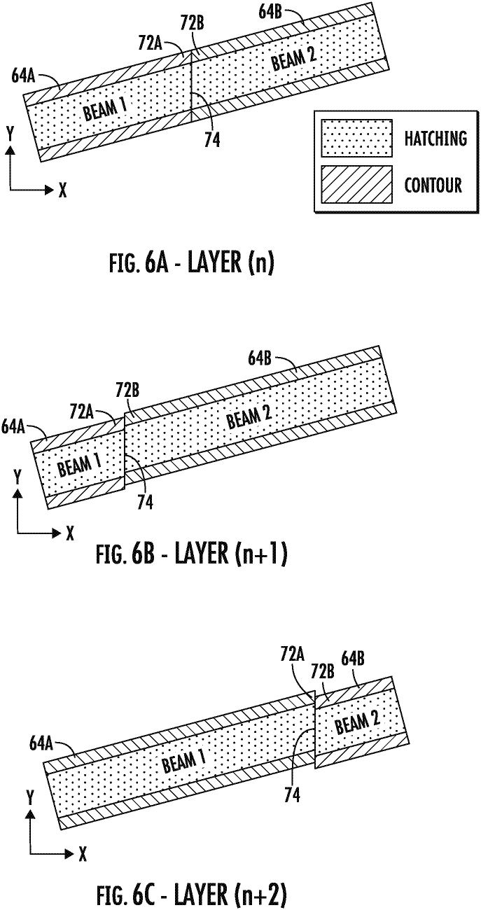

FIGS. 6A-C illustrate variations of the offset δY along Y for a sequence of N=3 slices which includes slice or layer n (FIG. 6A), slice n+1 (FIG. 6B), and slice n+2 (FIG. 6C). (FIGS. 6A-C also illustrate variation of the seam(n) X values similarly to FIGS. 5A-C.) For layer n, ends 72A and 72B are aligned along Y; there is a zero relative offset δY between ends 72A and 72B. For layer n+1, ends 72A and 72B are offset by a non-zero positive relative offset +δY between ends 72A and 72B along seam(n+1) 74. Positive in this case means that 72B is offset in the +Y direction relative to 72A. For layer n+2, ends 72A and 72B are offset by a non-zero negative relative offset -δY between ends 72A and 72B along seam(n+2) 74. Negative in this case means that 72B is offset in the -Y direction relative to 72A.

While FIGS. 6A-C provide an illustration of N=3, it is to be understood that N can be greater than 3. N can be at least 4, at least 5, at least 6, or some greater value. In an illustrative embodiment, the offset along the seam or along Y can be unique for each layer within the sequence of N layers.

As a second illustrative example, N = 5. For slice(n), ends 72A and 72B are nominally aligned along Y or along seam 74. For slice(n-2), end 72B is offset by -2*δY relative to end 72A along seam 74. For slice(n-1), end 72B is offset by -δY relative to end 72A along seam 74. For slice(n+1), end 72B is offset by +δY relative to end 72A along seam 74. For slice(n+1), end 72B is offset by +2*δY relative to end 72A along seam 74.

For the first and second illustrative examples, δY can be about 5 microns or about 0.005 mm. For some embodiments, δY can be greater to or less than 5 microns.

When both δX and δY are varied, as in FIGS. 6A-C., the magnitude δX >> δY. Generally, a ratio of δX divided by δY is more than 10, more than 20, more than 50, or more than 100. When δX = 1 mm = 1000 microns and δY = 5 microns, the ratio of δX divided by δY is 200. The ratio can be yet higher such as at least 500 or at least 1000.

A non-zero offset of end 72B versus end 72A along Y or seam 74 can vary between limits that are based upon the lateral uncertainly ΔY along Y. The non-zero offset can vary between about 5 microns to about 50% of ΔY. Thus, if ΔY is about 50 microns, the non-zero offset can vary between 5 and 25 microns. If ΔY is about 100 microns, then the non-zero offset can vary between 5 and 50 microns. If ΔY is about 200 microns, then the non-zero offset can vary between 5 and 100 microns.

A non-zero offset of end 72B versus end 72A along Y or seam 74 can vary between limits that are based upon a melt pool width (W). The melt pool width (W) is a width of molten metal that forms as the energy beam 32 scans along the build plane 28. The non-zero offset can vary between about 5 microns and a fraction of the melt width (W). The fraction can range from about 12.5% to about 50%. Thus, the non-zero offset can vary between about 5 microns and 0.125*W or about 5 microns and 0.25*W or about 5 microns and about 0.5*W. A typically melt pool width can be about 200 microns, putting the upper limit on a non-zero offset of about 25 microns, 50 microns, or about 100 microns.

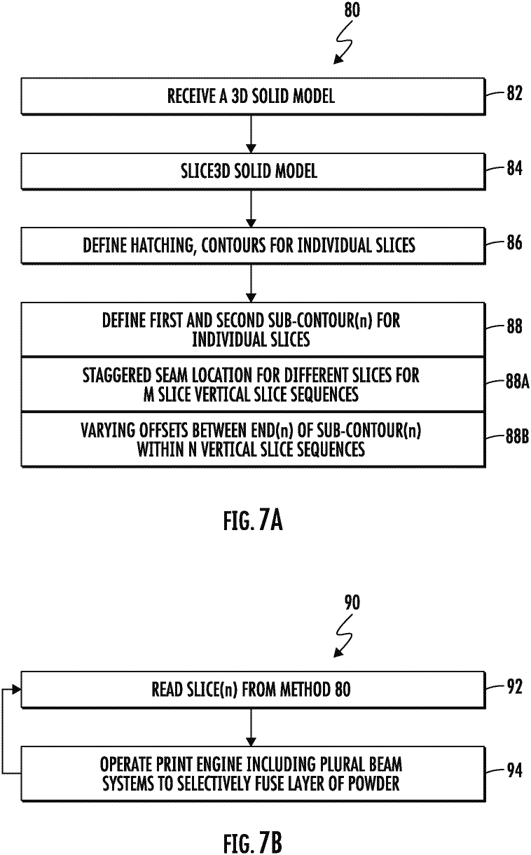

FIG. 7A is a flowchart that depicts a method 80 for preparing slice data for printing to be performed on a controller 8A. Reference can be made back to FIGS. 3A, 3B, 4, and 6A-C to understand element numbers. According to 82, a solid model that defines a 3D article 4 is received. According to 84, the solid model is sliced into layers or slices 55 one of which is slice(n) 55. According to 86, a contour(n) 64 and area fill hatch pattern 66 is defined for each individual slice(n) 55.

According to 88, a first sub-contour(n) 64A and second sub-contour(n) 64B is defined for each slice(n) 55. This is further elaborated in FIG. 7A by 88A and 88B. According to 88A, the a seam(n) location is defined for the pair of sub-contours(n) 64A/B for each slice(n) 55. Within a sequence of M slices 55, the seam(n) X location varies and is unique for each slice. According to 88B, varying offsets of ends (n) 72 along the seam(n) or axis Y are provided for each slice(n) 55. Within a sequence of N slices, the offset is unique for each slice(n) 55.

FIG. 7B is a flowchart for a method 90 for controller 8B. Method 90 is performed on slices from method 80 of FIG. 7A. According to 92, a slice(n) is read. According to 94, the print engine 6 including plural beam units 30 are operated to form a selectively fused layer of powder 24. Steps 92-94 are performed for all slices 55 until article 4 is fabricated.

The specific embodiments and applications thereof described above are for illustrative purposes only and do not preclude modifications and variations encompassed by the scope of the following claims.

What is claimed:

1. A three-dimensional (3D) printing system for forming a 3D article comprising:
a print engine including a motorized build plate, a coater, and a plurality of beam units at least including a first beam unit and a second beam unit, the coater configured to coat a layer of fusible powder over the motorized build plate to span a build plane, the first beam unit configured scan over a first lateral region of the build plane, the second beam unit configured to scan over a second lateral region of the build plane, the first and second lateral regions overlap over an overlap zone;
a controller configured to operate the motorized build plate, the coater, and the plurality of beam units to form the 3D article including forming a sequence of N selectively fused powder layers, N is at least 3, during forming the sequence of N selectively fused powder layers the controller is further configured to:
operate the first beam unit to selectively solidify a first sub-contour(n) having a first end(n) within the overlap zone;
operate the second beam unit to selectively solidify a second sub-contour(n) having a second end(n) within the overlap zone;
the first end(n) and the second end(n) connect to form a seam(n) that is oriented along a lateral Y-axis;
for N-1 layers the first end(n) and the second end(n) are offset with respect to each other along the seam(n) to define a Y-offset along the seam(n), the offset varying over the sequence of N selectively fused powder layers.

2. The three-dimensional (3D) printing system of claim 1 wherein the seam(n) has a varying location with respect to a lateral X-axis over a sequence of M selectively fused powder layers, the lateral X-axis is perpendicular to the lateral Y-axis, M is at least 3.

3. The three-dimensional (3D) printing system of claim 1 wherein the print engine includes a gas handling system configured to flow a non-oxidizing gas generally along the Y-axis during operation of the first and second beam units.

4. The three-dimensional (3D) printing system of claim 1 wherein within the sequence of N layers any two different layers have a difference in Y-offset of at least 5 microns.

5. The three-dimensional (3D) printing system of claim 4 wherein the first beam unit and the second beam unit have a relative alignment uncertainty ΔY along the Y-axis, the Y-offset is no more than 50% of ΔY.

6. The three-dimensional (3D) printing system of claim 4 wherein scanning of the beam units defines a melt pool width W, the Y-offset is no more than 50% of the melt pool width W.

7. The three-dimensional (3D) printing system of claim 1 wherein N is at least 4.

8. The three-dimensional (3D) printing system of claim 1 wherein N is at least 5.

9. A method for forming a three-dimensional (3D) article comprising:
providing a print engine including a motorized build plate, a coater, and a plurality of beam units including a first beam unit and a second beam unit, the coater configured to coat a layer of fusible powder over the motorized build plate to span a build plane, the first beam unit configured scan over a first lateral region of the build plane, the second beam unit configured to scan over a second lateral region of the build plane, the first and second lateral regions overlap over an overlap zone;
operating the first beam unit to selectively solidify a first sub-contour(n) having a first end(n) within the overlap zone;
operating the second beam unit to selectively solidify a second sub-contour(n) having a second end(n) within the overlap zone;
the first end(n) and the second end(n) connect to form a seam(n) that is oriented along a lateral Y-axis;
for N-1 layers the first end(n) and the second end(n) are offset with respect to each other along the seam(n) to define a Y-offset, the Y-offset varying over the sequence of N selectively fused powder layers.

10. The method of claim 9 wherein the seam(n) has a varying location with respect to a lateral X-axis over a sequence of M selectively fused powder layers, the lateral X-axis is perpendicular to the lateral Y-axis, M is at least 3.

11. The method of claim 9 wherein the print engine includes a gas handling system configured to flow a non-oxidizing gas generally along the Y-axis during operation of the first and second beam units.

12. The method of claim 9 wherein within the sequence of N layers any two different layers have a difference in Y-offset of at least 5 microns.

13. The method of claim 9 wherein the first beam unit and the second beam unit have a relative alignment uncertainty ΔY along the Y-axis, the Y-offset is no more than 50% of ΔY.

14. The method of claim 9 wherein N is at least 5.

15. A computer readable storage medium for operating a three dimensional (3D) printing system, the printing system including:
a print engine including a motorized build plate, a coater, and a plurality of beam units at least including a first beam unit and a second beam unit, the coater configured to coat a layer of fusible powder over the motorized build plate to span a build plane, the first beam unit configured scan over a first lateral region of the build plane, the second beam unit configured to scan over a second lateral region of the build plane, the first and second lateral regions overlap over an overlap zone; and
a controller, the computer readable storage unit being non-transitory and storing software instructions that in response to execution by a processor operate the motorized build plate, the coater, and the plurality of beam units to at least:
form the 3D article including forming a sequence of N selectively fused powder layers, N is at least 3, during forming the sequence of N selectively fused powder layers performing operations including:
operate the first beam unit to selectively solidify a first sub-contour(n) having a first end(n) within the overlap zone;
operate the second beam unit to selectively solidify a second sub-contour(n) having a second end(n) within the overlap zone;
the first end(n) and the second end(n) connect to form a seam(n) that is oriented along a lateral Y-axis;
for N-1 layers the first end(n) and the second end(n) are offset with respect to each other along the seam(n) to define a Y-offset, the Y-offset varying over the sequence of N selectively fused powder layers.

16. The computer readable storage unit of claim 15 wherein the seam(n) has a varying location with respect to a lateral X-axis over a sequence of M selectively fused powder layers, the lateral X-axis is perpendicular to the lateral Y-axis, M is at least 3.

17. The computer readable storage unit of claim 15 wherein the print engine includes a gas handling system configured to flow a non-oxidizing gas generally along the Y-axis during operation of the first and second beam units.

18. The computer readable storage unit of claim 15 wherein within the sequence of N layers any two different layers have a difference in Y-offset along the Y-axis between seam locations of at least 5 microns.

19. The computer readable storage unit of claim 15 wherein the first beam unit and the second beam unit have a relative alignment uncertainty ΔY along the Y-axis, the Y-offset is no more than 50% of ΔY.

20. The computer readable storage unit of claim 15 wherein N is at least 5.
